(19) United States
(12) Patent Application Publication
(10) Pub. No.: US 2026/0258294 A1
(43) Pub. Date: Sep. 3, 2026

(54) FAST-DISSOLVING POLYACRYLAMIDE FOR OFFSHORE OIL DISPLACEMENT AND PREPARATION METHOD THEREOF

(71) Applicant: HENAN ZHENGJIA GREEN ENERGY CO., LTD., Xinzheng City (CN)

(72) Inventors: Yanbin LIU, Xinzheng City (CN); Zhengzheng LIU, Xinzheng City (CN); Zhongqi WANG, Xinzheng City (CN); Bei JIA, Xinzheng City (CN); Haitao SHI, Xinzheng City (CN); Erxiao LI, Xinzheng City (CN)

(21) Appl. No.: 19/462,099

(22) Filed: Jan. 28, 2026

Related U.S. Application Data
(63) Continuation of application No. PCT/CN2023/117321, filed on Sep. 6, 2023.

(30) Foreign Application Priority Data
Jul. 29, 2023 (CN) 202310942240.2

(51) Int. Cl. C09K 8/588; C08F 220/56

(52) U.S. Cl. CPC C09K 8/588; C08F 220/56

(57) ABSTRACT

The present application discloses a fast-dissolving polyacrylamide for offshore oil displacement and a preparation method thereof, relating to the field of additives for oil extraction. The fast-dissolving polyacrylamide for offshore oil displacement is obtained by copolymerizing an acrylamide aqueous solution, an acrylic acid aqueous solution, an N-vinylpyrrolidone aqueous solution, a 2-acrylamide-2-methyl propanesulfonic acid aqueous solution, and a modified monomer solution, and then adding a cosolvent. Among them, a modified monomer in the modified monomer solution is prepared from a carbon-carbon double bond-containing glycidyl ester and diamino silicone oil under alkaline conditions. The fast-dissolving polyacrylamide for offshore oil displacement in the present application features high molecular weight, short dissolution time, high salt tolerance, and shear resistance, making it particularly suitable for offshore oil displacement.

### CROSS-REFERENCE TO RELATED APPLICATIONS

The present application is a continuation application of PCT application No. PCT/CN2023/117321, filed on Sep. 6, 2023, which claims priority to Chinese patent application No. 202310942240.2, filed on Jul. 29, 2023. The entireties of PCT application No. PCT/CN2023/117321 and Chinese patent application No. 202310942240.2 are hereby incorporated by reference herein and made a part of this specification.

### TECHNICAL FIELD

The present application relates to the field of additives for oil extraction, and particularly to a fast-dissolving polyacrylamide for offshore oil displacement and a preparation method thereof.

### BACKGROUND ART

Offshore oilfields are rich in resources and have great exploitable potential. Polyacrylamide is used as an oil displacement agent in the oil exploitation industry to increase the viscosity of the injected water, improve the oil-water flow ratio, and expand the sweep volume, thereby improving the oil recovery.

When used for offshore oil displacement, polyacrylamide is usually prepared by formulating with fresh water and diluting with seawater. Due to the highly mineralized water quality formed by various metal ions in seawater, the polyacrylamide used for oil displacement is required to have excellent salt tolerance. In addition, the molecular weight of polyacrylamide is a key factor determining its oil displacement effect. Polyacrylamide with a higher molecular weight is more favorable for improving the oil recovery. Therefore, the high molecular weight and high salt tolerance of polyacrylamide play a crucial role in improving the oil recovery.

Currently, in order to improve the molecular weight and salt tolerance of polyacrylamide, some people synthesize polyacrylamide with a molecular weight of up to 20 million using acrylamide, acrylic acid, N-vinylpyrrolidone, and quaternary ammonium salts as monomers, by selecting appropriate initiator systems, dosages, and reaction temperatures. Such polyacrylamide not only has an ultra-high molecular weight but also exhibits good salt tolerance. However, the dissolution time of this ultra-high-molecular-weight polyacrylamide is longer than 1 h, which severely affects oil recovery efficiency. On the other hand, during the dissolution and stirring process, polyacrylamide is inevitably subjected to shear forces. The ultra-high-molecular-weight polyacrylamide has poor shear resistance, easily leading to problems such as molecular chain breakage and viscosity reduction, resulting in a decrease in the water-oil flow ratio, which is unfavorable for improving the oil recovery.

### SUMMARY

In order to obtain a polyacrylamide with high molecular weight, short dissolution time, high salt tolerance and shear resistance suitable for offshore oil displacement, the present application provides a fast-dissolving polyacrylamide for offshore oil displacement and a preparation method thereof.

In a first aspect, the present application provides a method for preparing a fast-dissolving polyacrylamide for offshore oil displacement, which adopts the following technical solution:

A method for preparing a fast-dissolving polyacrylamide for offshore oil displacement includes the following steps:
adding 15-45 parts by weight of a carbon-carbon double bond-containing glycidyl ester and 10-25 parts by weight of a diamino silicone oil into 500-1,000 parts by weight of an alcohol solution, stirring uniformly to obtain a mixture, adjusting a pH value of the mixture to 9-10 with an alkali, then heating to 30-50° C. for reaction to obtain a modified monomer solution;
uniformly mixing 40-50 parts by weight of an acrylamide aqueous solution with a mass concentration of 20-40%, 10-15 parts by weight of an acrylic acid aqueous solution with a mass concentration of 10-30%, 5-10 parts by weight of an N-vinylpyrrolidone aqueous solution with a mass concentration of 0.3-0.8%, 10-20 parts by weight of a 2-acrylamide-2-methyl propanesulfonic acid aqueous solution with a mass concentration of 1-5%, and 15-25 parts by weight of the modified monomer solution, then adding 0.001-0.002 parts by weight of a shielding agent and 1-3 parts by weight of a chain transfer agent, stirring uniformly, and then purging with nitrogen to remove oxygen to obtain a mixed solution; and
adjusting a temperature of the mixed solution to (−2° C.) to 5° C., then under a protection of nitrogen, dropwise adding 3-5 parts by weight of an initiator aqueous solution with a mass concentration of 0.1%-0.3% into the mixed solution, reacting for 4-8 h after addition of the initiator aqueous solution is completed, then adding a cosolvent, stirring uniformly, followed by discharging, pelletizing, and drying to obtain the fast-dissolving polyacrylamide.

First, the modified monomer solution is prepared by reacting an epoxy group in the carbon-carbon double bond-containing glycidyl ester with an amino group in the diamino silicone oil. Then, acrylamide, acrylic acid, N-vinylpyrrolidone, and 2-acrylamide-2-methyl propanesulfonic acid are subjected to multi-component copolymerization with a modified monomer in the modified monomer solution to obtain the polyacrylamide with high molecular weight, high-temperature resistance, high salt tolerance and shear resistance, which can prevent the problem of rapid viscosity decline of polyacrylamide under shear or high-salinity conditions, so that the water-oil flow ratio does not decrease rapidly, thereby improving the oil recovery.

Among them, the acrylamide, acrylic acid, N-vinylpyrrolidone, and 2-acrylamide-2-methyl propanesulfonic acid are formulated into an aqueous solution with a specific concentration, which is beneficial to improving the safety in the production process of polyacrylamide and is also beneficial to increasing the molecular weight of polyacrylamide. Before adding the initiator aqueous solution, the temperature of the mixed solution is adjusted to (−2° C.) to 5° C., which is beneficial to preventing explosive polymerization that may cause localized high temperature and chain breakage of polyacrylamide, and is also beneficial to increasing the molecular weight of polyacrylamide.

In addition, with the addition of the co-solvent, the co-solvent absorbs water and swells, thereby generating micropores within the particles. Water is “sucked” into the particles through capillary action. Through repeated water absorption and swelling, intact solid polyacrylamide particles are quickly disintegrated into fine particles or powder, thereby increasing the specific surface area and improving the dissolution rate. Due to the accelerated dissolution rate of polyacrylamide, the dissolution time is saved, thereby improving the oil recovery efficiency.

Optionally, the carbon-carbon double bond-containing glycidyl ester has a molecular formula of CH₂═CHCH₂(OCH₂CH₂)ₙOCH₂COOCH₂CH(O)CH₂, wherein n ranges from 5 to 20.

Compared with using glycidyl methacrylate, when using the carbon-carbon double bond-containing glycidyl ester having the molecular formula of CH₂═CHCH₂(OCH₂CH₂)ₙOCH₂COOCH₂CH(O)CH₂ with n ranging from 5 to 20 as the glycidyl ester, the shear-resistant viscosity retention rate of polyacrylamide can reach over 80%, and the viscosity retention rate after 1 month of thermal aging exceeds 80%. As a result, the shear resistance, high-temperature resistance, and high salt tolerance of polyacrylamide are significantly improved.

Optionally, the n ranges from 8 to 12.

A value of the n ranging from 8 to 12 is beneficial for further improving the shear resistance, high-temperature resistance, and high salt tolerance of the polyacrylamide.

Optionally, the diamino silicone oil is diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m ranges from 10 to 30.

The amino groups at both ends of the diaminopropyl polydimethylsiloxane react with the epoxy groups of the carbon-carbon double bond-containing glycidyl ester to obtain a modified monomer, which is then copolymerized with acrylamide, acrylic acid, N-vinylpyrrolidone, and 2-acrylamide-2-methyl propanesulfonic acid, thereby simultaneously and effectively improving the molecular weight, high-temperature resistance, and shear resistance of polyacrylamide. Among them, when m ranges from 10 to 30, the shear-resistant viscosity retention rate of polyacrylamide can reach over 80%, and the viscosity retention rate after 1 month of thermal aging exceeds 80%.

Optionally, the m ranges from 15 to 20.

A value of the m ranging from 15 to 20 is beneficial for further improving the shear resistance, high-temperature resistance, and high salt tolerance of the polyacrylamide.

Optionally, the modified monomer solution includes 20-28 parts by weight of the carbon-carbon double bond-containing glycidyl ester, 14-18 parts by weight of the diamino silicone oil, and 600-800 parts by weight of the alcohol solution.

When the carbon-carbon double bond-containing glycidyl ester is within a range of 20-28 parts by weight, the diamino silicone oil is within a range of 14-18 parts by weight, and the alcohol solution is within a range of 600-800 parts by weight, the modified monomer obtained is copolymerized with acrylamide, acrylic acid, N-vinylpyrrolidone, and 2-acrylamide-2-methyl propanesulfonic acid, thereby further improving the shear resistance, high-temperature resistance, and high salt tolerance of the polyacrylamide.

Optionally, before adding the initiator solution, the temperature of the mixed solution is (−1° C.) to 1° C.

Before adding the initiator solution, the temperature of the mixed solution is within a range of (−1° C.) to 1° C., thereby further improving the shear resistance, high-temperature resistance, and high salt tolerance of the polyacrylamide.

Optionally, the initiator aqueous solution is added in three portions; an amount of a first addition of the initiator aqueous solution is 25-35 wt % of a total amount of the initiator aqueous solution, with a dropwise addition rate of 0.05-0.1 g/min; an amount of a second addition of the initiator aqueous solution is 40-50 wt % of the total amount of the initiator aqueous solution, with a dropwise addition rate of 0.1-0.2 g/min; and a dropwise addition rate for a third addition of the initiator aqueous solution is 0.2-0.5 g/min, and an interval time between two successive additions of the initiator aqueous solution is 30-45 minutes.

The initiator aqueous solution is added in multiple portions and is added dropwise in a slow-to-fast manner, thereby further improving the stability of the high-temperature resistance and high salt tolerance of the polyacrylamide.

Optionally, the initiator aqueous solution is formulated with an initiator and water, and the initiator is one or more of a water-soluble azo initiator or a persulfate initiator.

The water-soluble azo initiator is one or more of azodiisobutylamidine hydrochloride or azodiisobutylimidazoline hydrochloride.

The persulfate initiator is one or more of potassium persulfate, sodium persulfate, or ammonium persulfate.

Optionally, the cosolvent is one or more selected from a group consisting of sodium carboxymethyl starch, sodium starch glycolate, polyvinylpyrrolidone, and sodium carboxymethylcellulose.

As described above, the co-solvent can absorb water and swell, thereby generating micropores within the polyacrylamide particles. Water is “sucked” into the particles through capillary action. Through repeated water absorption and swelling, intact solid polyacrylamide particles are quickly disintegrated into fine particles or powder, thereby increasing the specific surface area and improving the dissolution rate.

Optionally, the shielding agent is one or two of disodium ethylenediamine tetraacetate or sodium diethylenetriamine pentaacetate.

Optionally, the chain transfer agent is isopropanol or sodium formate.

In a second aspect, the present application provides a polyacrylamide, which is prepared by any one of the above methods for preparing a fast-dissolving polyacrylamide for offshore oil displacement.

In summary, compared with the prior art, the present application includes at least the following beneficial effects:
1. Acrylamide, acrylic acid, N-vinylpyrrolidone, and 2-acrylamide-2-methyl propanesulfonic acid are subjected to multi-component copolymerization with the modified monomer in the modified monomer solution to obtain the polyacrylamide with high molecular weight, high-temperature resistance, high salt tolerance and shear resistance, which can prevent the problem of rapid viscosity decline of polyacrylamide under shear or high-salinity conditions, so that the water-oil flow ratio does not decrease rapidly, thereby improving the oil recovery.
2. The initiator aqueous solution is added in multiple portions and is added dropwise in a slow-to-fast manner, thereby further improving the stability of the high-temperature resistance and high salt tolerance of polyacrylamide.

### DETAILED DESCRIPTION

The present application will be further described in detail below with reference to experiments.

### EXAMPLES

### Example 1

A fast-dissolving polyacrylamide for offshore oil displacement, with its preparation method including the following steps:

Preparation of a modified monomer solution: 15 kg of a carbon-carbon double bond-containing glycidyl ester and 10 kg of a diamino silicone oil were added into 500 kg of an isopropanol solution with a mass fraction of 20%, stirred uniformly to obtain a mixture, a pH value of the mixture was adjusted to 9 with sodium hydroxide, then the mixture was heated to 40° C. for reaction to obtain a modified monomer solution. Among them, the carbon-carbon double bond-containing glycidyl ester contained a polyether segment and had a molecular formula of CH₂═CHCH₂(OCH₂CH₂)ₙOCH₂COOCH₂CH(O)CH₂, wherein n was 5; the diamino silicone oil used was diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m was 10.

Preparation of a mixed solution: 40 kg of an acrylamide aqueous solution with a mass concentration of 30%, 10 kg of an acrylic acid aqueous solution with a mass concentration of 20%, 5 kg of an N-vinylpyrrolidone aqueous solution with a mass concentration of 0.5%, 20 kg of a 2-acrylamide-2-methyl propanesulfonic acid aqueous solution with a mass concentration of 3%, and 25 kg of the modified monomer solution were mixed uniformly, then 0.001 kg of a shielding agent and 1 kg of a chain transfer agent were added, stirred uniformly, and then purged with nitrogen to remove oxygen to obtain a mixed solution. Among them, the shielding agent used was disodium ethylenediamine tetraacetate, and the chain transfer agent used was sodium formate.

Preparation of polyacrylamide: a temperature of the mixed solution was adjusted to −2° C., then under a protection of nitrogen, 3 kg of an initiator aqueous solution with a mass concentration of 0.2% was dropwise added into the mixed solution at a rate of 0.15 g/min; reacted for 6 h after the addition of the initiator aqueous solution was completed, then a cosolvent was added, stirred uniformly, followed by discharging, pelletizing, and drying to obtain the polyacrylamide. Among them, the initiator aqueous solution was an ammonium persulfate aqueous solution, and the cosolvent was polyvinylpyrrolidone. [0047][Example 2]

A fast-dissolving polyacrylamide for offshore oil displacement, with its preparation method including the following steps:

Preparation of a modified monomer solution: 25 kg of a carbon-carbon double bond-containing glycidyl ester and 16 kg of diamino silicone oil were added into 700 kg of an isopropanol solution with a mass fraction of 20%, stirred uniformly to obtain a mixture, a pH value of the mixture was adjusted to 9 with sodium hydroxide, then the mixture was heated to 40° C. for reaction to obtain a modified monomer solution. Among them, the carbon-carbon double bond-containing glycidyl ester contained a polyether segment and had a molecular formula of CH₂═CHCH₂(OCH₂CH₂)ₙOCH₂COOCH₂CH(O)CH₂, wherein n was 5; the diamino silicone oil used was diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m was 10.

Preparation of a mixed solution: 40 kg of an acrylamide aqueous solution with a mass concentration of 30%, 10 kg of an acrylic acid aqueous solution with a mass concentration of 20%, 5 kg of an N-vinylpyrrolidone aqueous solution with a mass concentration of 0.5%, 20 kg of a 2-acrylamide-2-methyl propanesulfonic acid aqueous solution with a mass concentration of 3%, and 25 kg of the modified monomer solution were mixed uniformly, then 0.001 kg of a shielding agent and 1 kg of a chain transfer agent were added, stirred uniformly, and then purged with nitrogen to remove oxygen to obtain a mixed solution. Among them, the shielding agent used was disodium ethylenediamine tetraacetate, and the chain transfer agent used was sodium formate.

Preparation of polyacrylamide: a temperature of the mixed solution was adjusted to −2° C., then under a protection of nitrogen, 3 kg of an initiator aqueous solution with a mass concentration of 0.2% was dropwise added into the mixed solution at a rate of 0.15 g/min; reacted for 6 h after the addition of the initiator aqueous solution was completed, then a cosolvent was added, stirred uniformly, followed by discharging, pelletizing, and drying to obtain the polyacrylamide. Among them, the initiator aqueous solution was an ammonium persulfate aqueous solution, and the cosolvent was polyvinylpyrrolidone.

### Example 3

A fast-dissolving polyacrylamide for offshore oil displacement, with its preparation method including the following steps:

Preparation of a modified monomer solution: 45 kg of a carbon-carbon double bond-containing glycidyl ester and 25 kg of diamino silicone oil were added into 1,000 kg of an isopropanol solution with a mass fraction of 20%, stirred uniformly to obtain a mixture, a pH value of the mixture was adjusted 9 with sodium hydroxide, then the mixture was heated to 40° C. for reaction to obtain a modified monomer solution. Among them, the carbon-carbon double bond-containing glycidyl ester contained a polyether segment and had a molecular formula of CH₂═CHCH₂(OCH₂CH₂)ₙOCH₂COOCH₂CH(O)CH₂, wherein n was 5; the diamino silicone oil used was diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m was 10.

Preparation of a mixed solution: 40 kg of an acrylamide aqueous solution with a mass concentration of 30%, 10 kg of an acrylic acid aqueous solution with a mass concentration of 20%, 5 kg of an N-vinylpyrrolidone aqueous solution with a mass concentration of 0.5%, 20 kg of a 2-acrylamide-2-methyl propanesulfonic acid aqueous solution with a mass concentration of 3%, and 25 kg of the modified monomer solution were mixed uniformly, then 0.001 kg of a shielding agent and 1 kg of a chain transfer agent were added, stirred uniformly, and then purged with nitrogen to remove oxygen to obtain a mixed solution. Among them, the shielding agent used was disodium ethylenediamine tetraacetate, and the chain transfer agent used was sodium formate.

Preparation of polyacrylamide: a temperature of the mixed solution was adjusted to −2° C., then under a protection of nitrogen, 3 kg of an initiator aqueous solution with a mass concentration of 0.2% was dropwise added into the mixed solution at a rate of 0.15 g/min; reacted for 6 h after the addition of the initiator aqueous solution was completed, then a cosolvent was added, stirred uniformly, followed by discharging, pelletizing, and drying to obtain the polyacrylamide. Among them, the initiator aqueous solution was an ammonium persulfate aqueous solution, and the cosolvent was polyvinylpyrrolidone.

### Example 4

A fast-dissolving polyacrylamide for offshore oil displacement, with its preparation method including the following steps:

Preparation of a modified monomer solution: 25 kg of a carbon-carbon double bond-containing glycidyl ester and 16 kg of diamino silicone oil were added into 700 kg of an isopropanol solution with a mass fraction of 20%, stirred uniformly to obtain a mixture, a pH value of the mixture was adjusted to 9 with sodium hydroxide, then the mixture was heated to 40° C. for reaction to obtain a modified monomer solution. Among them, the carbon-carbon double bond-containing glycidyl ester contained a polyether segment and had a molecular formula of CH₂═CHCH₂(OCH₂CH₂)ₙOCH₂COOCH₂CH(O)CH₂, wherein n was 5; the diamino silicone oil used was diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m was 10.

Preparation of a mixed solution: 45 kg of an acrylamide aqueous solution with a mass concentration of 30%, 12.5 kg of an acrylic acid aqueous solution with a mass concentration of 20%, 7.5 kg of an N-vinylpyrrolidone aqueous solution with a mass concentration of 0.5%, 15 kg of a 2-acrylamide-2-methyl propanesulfonic acid aqueous solution with a mass concentration of 3%, and 20 kg of the modified monomer solution were mixed uniformly, then 0.0015 kg of a shielding agent and 2 kg of a chain transfer agent were added, stirred uniformly, and then purged with nitrogen to remove oxygen to obtain a mixed solution. Among them, the shielding agent used was disodium ethylenediamine tetraacetate, and the chain transfer agent used was sodium formate.

Preparation of polyacrylamide: a temperature of the mixed solution was adjusted to −2° C., then under a protection of nitrogen, 4 kg of an initiator aqueous solution with a mass concentration of 0.2% was dropwise added into the mixed solution at a rate of 0.15 g/min; reacted for 6 h after the addition of the initiator aqueous solution was completed, then a cosolvent was added, stirred uniformly, followed by discharging, pelletizing, and drying to obtain the polyacrylamide. Among them, the initiator aqueous solution was an ammonium persulfate aqueous solution, and the cosolvent was polyvinylpyrrolidone. [0062][Example 5]

A fast-dissolving polyacrylamide for offshore oil displacement, with its preparation method including the following steps:

Preparation of a modified monomer solution: 25 kg of a carbon-carbon double bond-containing glycidyl ester and 16 kg of diamino silicone oil were added into 700 kg of an isopropanol solution with a mass fraction of 20%, stirred uniformly to obtain a mixture, a pH value of the mixture was adjusted to 9 with sodium hydroxide, then the mixture was heated to 40° C. for reaction to obtain a modified monomer solution. Among them, the carbon-carbon double bond-containing glycidyl ester contained a polyether segment and had a molecular formula of CH₂═CHCH₂(OCH₂CH₂)ₙOCH₂COOCH₂CH(O)CH₂, wherein n was 5; the diamino silicone oil used was diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m was 10.

Preparation of a mixed solution: 50 kg of an acrylamide aqueous solution with a mass concentration of 30%, 15 kg of an acrylic acid aqueous solution with a mass concentration of 20%, 10 kg of an N-vinylpyrrolidone aqueous solution with a mass concentration of 0.5%, 10 kg of a 2-acrylamide-2-methyl propanesulfonic acid aqueous solution with a mass concentration of 3%, and 15 kg of the modified monomer solution were mixed uniformly, then 0.002 kg of a shielding agent and 3 kg of a chain transfer agent were added, stirred uniformly, and then purged with nitrogen to remove oxygen to obtain a mixed solution. Among them, the shielding agent used was disodium ethylenediamine tetraacetate, and the chain transfer agent used was sodium formate.

Preparation of polyacrylamide: a temperature of the mixed solution was adjusted to −2° C., then under a protection of nitrogen, 5 kg of an initiator aqueous solution with a mass concentration of 0.2% was dropwise added into the mixed solution at a rate of 0.15 g/min; reacted for 6 h after the addition of the initiator aqueous solution was completed, then a cosolvent was added, stirred uniformly, followed by discharging, pelletizing, and drying to obtain the polyacrylamide. Among them, the initiator aqueous solution was an ammonium persulfate aqueous solution, and the cosolvent was polyvinylpyrrolidone.

### Example 6

A fast-dissolving polyacrylamide for offshore oil displacement, with its preparation method including the following steps:

Preparation of a modified monomer solution: 25 kg of a carbon-carbon double bond-containing glycidyl ester and 16 kg of diamino silicone oil were added into 700 kg of an isopropanol solution with a mass fraction of 20%, stirred uniformly to obtain a mixture, a pH value of the mixture was adjusted to 9 with sodium hydroxide, then the mixture was heated to 40° C. for reaction to obtain a modified monomer solution. Among them, the carbon-carbon double bond-containing glycidyl ester contained a polyether segment and had a molecular formula of CH₂═CHCH₂(OCH₂CH₂)ₙOCH₂COOCH₂CH(O)CH₂, wherein n was 10; the diamino silicone oil used was diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m was 10.

Preparation of a mixed solution: 45 kg of an acrylamide aqueous solution with a mass concentration of 30%, 12.5 kg of an acrylic acid aqueous solution with a mass concentration of 20%, 7.5 kg of an N-vinylpyrrolidone aqueous solution with a mass concentration of 0.5%, 15 kg of a 2-acrylamide-2-methyl propanesulfonic acid aqueous solution with a mass concentration of 3%, and 20 kg of the modified monomer solution were mixed uniformly, then 0.0015 kg of a shielding agent and 2 kg of a chain transfer agent were added, stirred uniformly, and then purged with nitrogen to remove oxygen to obtain a mixed solution. Among them, the shielding agent used was disodium ethylenediamine tetraacetate, and the chain transfer agent used was sodium formate.

Preparation of polyacrylamide: a temperature of the mixed solution was adjusted to −2° C., then under a protection of nitrogen, 4 kg of an initiator aqueous solution with a mass concentration of 0.2% was dropwise added into the mixed solution at a rate of 0.15 g/min; reacted for 6 h after the addition of the initiator aqueous solution was completed, then a cosolvent was added, stirred uniformly, followed by discharging, pelletizing, and drying to obtain the polyacrylamide. Among them, the initiator aqueous solution was an ammonium persulfate aqueous solution, and the cosolvent was polyvinylpyrrolidone.

### Example 7

A fast-dissolving polyacrylamide for offshore oil displacement, with its preparation method including the following steps:

Preparation of a modified monomer solution: 25 kg of a carbon-carbon double bond-containing glycidyl ester and 16 kg of diamino silicone oil were added into 700 kg of an isopropanol solution with a mass fraction of 20%, stirred uniformly to obtain a mixture, a pH value of the mixture was adjusted to 9 with sodium hydroxide, then the mixture was heated to 40° C. for reaction to obtain a modified monomer solution. Among them, the carbon-carbon double bond-containing glycidyl ester contained a polyether segment and had a molecular formula of CH₂═CHCH₂(OCH₂CH₂)ₙOCH₂COOCH₂CH(O)CH₂, wherein n was 20; the diamino silicone oil used was diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m was 10.

Preparation of a mixed solution: 45 kg of an acrylamide aqueous solution with a mass concentration of 30%, 12.5 kg of an acrylic acid aqueous solution with a mass concentration of 20%, 7.5 kg of an N-vinylpyrrolidone aqueous solution with a mass concentration of 0.5%, 15 kg of a 2-acrylamide-2-methyl propanesulfonic acid aqueous solution with a mass concentration of 3%, and 20 kg of the modified monomer solution were mixed uniformly, then 0.0015 kg of a shielding agent and 2 kg of a chain transfer agent were added, stirred uniformly, and then purged with nitrogen to remove oxygen to obtain a mixed solution. Among them, the shielding agent used was disodium ethylenediamine tetraacetate, and the chain transfer agent used was sodium formate.

Preparation of polyacrylamide: a temperature of the mixed solution was adjusted to −2° C., then under a protection of nitrogen, 4 kg of an initiator aqueous solution with a mass concentration of 0.2% was dropwise added into the mixed solution at a rate of 0.15 g/min; reacted for 6 h after the addition of the initiator aqueous solution was completed, then a cosolvent was added, stirred uniformly, followed by discharging, pelletizing, and drying to obtain the polyacrylamide. Among them, the initiator aqueous solution was an ammonium persulfate aqueous solution, and the cosolvent was polyvinylpyrrolidone.

### Example 8

A fast-dissolving polyacrylamide for offshore oil displacement, with its preparation method including the following steps:

Preparation of a modified monomer solution: 25 kg of a carbon-carbon double bond-containing glycidyl ester and 16 kg of diamino silicone oil were added into 700 kg of an isopropanol solution with a mass fraction of 20%, stirred uniformly to obtain a mixture, a pH value of the mixture was adjusted to 9 with sodium hydroxide, then the mixture was heated to 40° C. for reaction to obtain a modified monomer solution. Among them, the carbon-carbon double bond-containing glycidyl ester contained a polyether segment and had a molecular formula of CH₂═CHCH₂(OCH₂CH₂)ₙOCH₂COOCH₂CH(O)CH₂, wherein n was 10; the diamino silicone oil used was diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m was 18.

Preparation of a mixed solution: 45 kg of an acrylamide aqueous solution with a mass concentration of 30%, 12.5 kg of an acrylic acid aqueous solution with a mass concentration of 20%, 7.5 kg of an N-vinylpyrrolidone aqueous solution with a mass concentration of 0.5%, 15 kg of a 2-acrylamide-2-methyl propanesulfonic acid aqueous solution with a mass concentration of 3%, and 20 kg of the modified monomer solution were mixed uniformly, then 0.0015 kg of a shielding agent and 2 kg of a chain transfer agent were added, stirred uniformly, and then purged with nitrogen to remove oxygen to obtain a mixed solution. Among them, the shielding agent used was disodium ethylenediamine tetraacetate, and the chain transfer agent used was sodium formate.

Preparation of polyacrylamide: a temperature of the mixed solution was adjusted to −2° C., then under a protection of nitrogen, 4 kg of an initiator aqueous solution with a mass concentration of 0.2% was dropwise added into the mixed solution at a rate of 0.15 g/min; reacted for 6 h after the addition of the initiator aqueous solution was completed, then a cosolvent was added, stirred uniformly, followed by discharging, pelletizing, and drying to obtain the polyacrylamide. Among them, the initiator aqueous solution was an ammonium persulfate aqueous solution, and the cosolvent was polyvinylpyrrolidone.

### Example 9

A fast-dissolving polyacrylamide for offshore oil displacement, with its preparation method including the following steps:

Preparation of a modified monomer solution: 25 kg of a carbon-carbon double bond-containing glycidyl ester and 16 kg of diamino silicone oil were added into 700 kg of an isopropanol solution with a mass fraction of 20%, stirred uniformly to obtain a mixture, a pH value of the mixture was adjusted to 9 with sodium hydroxide, then the mixture was heated to 40° C. for reaction to obtain a modified monomer solution. Among them, the carbon-carbon double bond-containing glycidyl ester contained a polyether segment and had a molecular formula of CH₂═CHCH₂(OCH₂CH₂)ₙOCH₂COOCH₂CH(O)CH₂, wherein n was 10; the diamino silicone oil used was diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m was 30.

Preparation of a mixed solution: 45 kg of an acrylamide aqueous solution with a mass concentration of 30%, 12.5 kg of an acrylic acid aqueous solution with a mass concentration of 20%, 7.5 kg of an N-vinylpyrrolidone aqueous solution with a mass concentration of 0.5%, 15 kg of a 2-acrylamide-2-methyl propanesulfonic acid aqueous solution with a mass concentration of 3%, and 20 kg of the modified monomer solution were mixed uniformly, then 0.0015 kg of a shielding agent and 2 kg of a chain transfer agent were added, stirred uniformly, and then purged with nitrogen to remove oxygen to obtain a mixed solution. Among them, the shielding agent used was disodium ethylenediamine tetraacetate, and the chain transfer agent used was sodium formate.

Preparation of polyacrylamide: a temperature of the mixed solution was adjusted to −2° C., then under a protection of nitrogen, 4 kg of an initiator aqueous solution with a mass concentration of 0.2% was dropwise added into the mixed solution at a rate of 0.15 g/min; reacted for 6 h after the addition of the initiator aqueous solution was completed, then a cosolvent was added, stirred uniformly, followed by discharging, pelletizing, and drying to obtain the polyacrylamide. Among them, the initiator aqueous solution was an ammonium persulfate aqueous solution, and the cosolvent was polyvinylpyrrolidone.

### Example 10

A fast-dissolving polyacrylamide for offshore oil displacement, with its preparation method including the following steps:

Preparation of a modified monomer solution: 25 kg of a carbon-carbon double bond-containing glycidyl ester and 16 kg of diamino silicone oil were added into 700 kg of an isopropanol solution with a mass fraction of 20%, stirred uniformly to obtain a mixture, a pH value of the mixture was adjusted to 9 with sodium hydroxide, then the mixture was heated to 40° C. for reaction to obtain a modified monomer solution. Among them, the carbon-carbon double bond-containing glycidyl ester contained a polyether segment and had a molecular formula of CH₂═CHCH₂(OCH₂CH₂)ₙOCH₂COOCH₂CH(O)CH₂, wherein n was 10; the diamino silicone oil used was diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m was 18.

Preparation of a mixed solution: 45 kg of an acrylamide aqueous solution with a mass concentration of 30%, 12.5 kg of an acrylic acid aqueous solution with a mass concentration of 20%, 7.5 kg of an N-vinylpyrrolidone aqueous solution with a mass concentration of 0.5%, 15 kg of a 2-acrylamide-2-methyl propanesulfonic acid aqueous solution with a mass concentration of 3%, and 20 kg of the modified monomer solution were mixed uniformly, then 0.0015 kg of a shielding agent and 2 kg of a chain transfer agent were added, stirred uniformly, and then purged with nitrogen to remove oxygen to obtain a mixed solution. Among them, the shielding agent used was disodium ethylenediamine tetraacetate, and the chain transfer agent used was sodium formate.

Preparation of polyacrylamide: a temperature of the mixed solution was adjusted to −2° C., then under a protection of nitrogen, 4 kg of an initiator aqueous solution with a mass concentration of 0.2% was dropwise added into the mixed solution.

An initiator aqueous solution was added in three portions; an amount of a first addition of the initiator aqueous solution was 30 wt % of a total amount of the initiator aqueous solution, with a dropwise addition rate of 0.05 g/min; an amount of a second addition of the initiator aqueous solution was 45 wt % of the total amount of the initiator aqueous solution, with a dropwise addition rate of 0.15 g/min; the remaining initiator aqueous solution was added in a third addition and a dropwise addition rate for the third addition of the initiator aqueous solution was 0.4 g/min, and an interval time between two successive additions of the initiator aqueous solution was 45 minutes.

A resulting mixture was reacted for 6 h after the addition of the initiator aqueous solution was completed, then a cosolvent was added, stirred uniformly, followed by discharging, pelletizing, and drying to obtain the polyacrylamide. Among them, the initiator aqueous solution was an ammonium persulfate aqueous solution, and the cosolvent was polyvinylpyrrolidone.

### Example 11

A fast-dissolving polyacrylamide for offshore oil displacement, with its preparation method including the following steps:

Preparation of a modified monomer solution: 25 kg of a carbon-carbon double bond-containing glycidyl ester and 16 kg of diamino silicone oil were added into 700 kg of an isopropanol solution with a mass fraction of 20%, stirred uniformly to obtain a mixture, a pH value of the mixture was adjusted to 9 with sodium hydroxide, then the mixture was heated to 40° C. for reaction to obtain a modified monomer solution. Among them, the carbon-carbon double bond-containing glycidyl ester contained a polyether segment and had a molecular formula of CH₂═CHCH₂(OCH₂CH₂)ₙOCH₂COOCH₂CH(O)CH₂, wherein n was 10; the diamino silicone oil used was diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m was 18.

Preparation of a mixed solution: 45 kg of an acrylamide aqueous solution with a mass concentration of 30%, 12.5 kg of an acrylic acid aqueous solution with a mass concentration of 20%, 7.5 kg of an N-vinylpyrrolidone aqueous solution with a mass concentration of 0.5%, 15 kg of a 2-acrylamide-2-methyl propanesulfonic acid aqueous solution with a mass concentration of 3%, and 20 kg of the modified monomer solution were mixed uniformly, then 0.0015 kg of a shielding agent and 2 kg of a chain transfer agent were added, stirred uniformly, and then purged with nitrogen to remove oxygen to obtain a mixed solution. Among them, the shielding agent used was disodium ethylenediamine tetraacetate, and the chain transfer agent used was sodium formate.

Preparation of polyacrylamide: a temperature of the mixed solution was adjusted to −2° C., then under a protection of nitrogen, 4 kg of an initiator aqueous solution with a mass concentration of 0.2% was dropwise added into the mixed solution.

An initiator aqueous solution was added in three portions; an amount of a first addition of the initiator aqueous solution was 30 wt % of a total amount of the initiator aqueous solution, with a dropwise addition rate of 0.15 g/min; an amount of a second addition of the initiator aqueous solution was 45 wt % of the total amount of the initiator aqueous solution, with a dropwise addition rate of 0.15 g/min; the remaining initiator aqueous solution was added in a third addition and a dropwise addition rate for the third addition of the initiator aqueous solution was 0.15 g/min, and an interval time between two successive additions of the initiator aqueous solution was 45 minutes.

A resulting mixture was reacted for 6 h after the addition of the initiator aqueous solution was completed, then a cosolvent was added, stirred uniformly, followed by discharging, pelletizing, and drying to obtain the polyacrylamide. Among them, the initiator aqueous solution was an ammonium persulfate aqueous solution, and the cosolvent was polyvinylpyrrolidone.

### Example 12

A fast-dissolving polyacrylamide for offshore oil displacement, with its preparation method including the following steps:

Preparation of a modified monomer solution: 25 kg of a carbon-carbon double bond-containing glycidyl ester and 16 kg of diamino silicone oil were added into 700 kg of an isopropanol solution with a mass fraction of 20%, stirred uniformly to obtain a mixture, a pH value of the mixture was adjusted to 9 with sodium hydroxide, then the mixture was heated to 40° C. for reaction to obtain a modified monomer solution. Among them, the carbon-carbon double bond-containing glycidyl ester contained a polyether segment and had a molecular formula of CH₂═CHCH₂(OCH₂CH₂)ₙOCH₂COOCH₂CH(O)CH₂, wherein n was 10; the diamino silicone oil used was diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m was 18.

Preparation of a mixed solution: 45 kg of an acrylamide aqueous solution with a mass concentration of 30%, 12.5 kg of an acrylic acid aqueous solution with a mass concentration of 20%, 7.5 kg of an N-vinylpyrrolidone aqueous solution with a mass concentration of 0.5%, 15 kg of a 2-acrylamide-2-methyl propanesulfonic acid aqueous solution with a mass concentration of 3%, and 20 kg of the modified monomer solution were mixed uniformly, then 0.0015 kg of a shielding agent and 2 kg of a chain transfer agent were added, stirred uniformly, and then purged with nitrogen to remove oxygen to obtain a mixed solution. Among them, the shielding agent used was disodium ethylenediamine tetraacetate, and the chain transfer agent used was sodium formate.

Preparation of polyacrylamide: a temperature of the mixed solution was adjusted to −2° C., then under a protection of nitrogen, 4 kg of an initiator aqueous solution with a mass concentration of 0.2% was dropwise added into the mixed solution.

An initiator aqueous solution was added in three portions; an amount of a first addition of the initiator aqueous solution was 30 wt % of a total amount of the initiator aqueous solution, with a dropwise addition rate of 0.4 g/min; an amount of a second addition of the initiator aqueous solution was 45 wt % of the total amount of the initiator aqueous solution, with a dropwise addition rate of 0.15 g/min; the remaining initiator aqueous solution was added in a third addition and a dropwise addition rate for the third addition of the initiator aqueous solution was 0.05 g/min, and an interval time between two successive additions of the initiator aqueous solution was 45 minutes.

A resulting mixture was reacted for 6 h after the addition of the initiator aqueous solution was completed, then a cosolvent was added, stirred uniformly, followed by discharging, pelletizing, and drying to obtain the polyacrylamide. Among them, the initiator aqueous solution was an ammonium persulfate aqueous solution, and the cosolvent was polyvinylpyrrolidone.

### COMPARATIVE EXAMPLES

### Comparative Example 1

A fast-dissolving polyacrylamide for offshore oil displacement differs from Example 1 in that the modified monomer solution is different. In this comparative example, the preparation process of the modified monomer solution was as follows:

15 kg of a carbon-carbon double bond-containing glycidyl ester and 10 kg of polydimethylsiloxane with a viscosity of 500 cp were added into 500 kg of an isopropanol solution with a mass fraction of 20%, stirred uniformly to obtain a mixture, a pH value of the mixture was adjusted to 9 with sodium hydroxide, then the mixture was heated to 40° C. for reaction to obtain a modified monomer solution. Among them, the carbon-carbon double bond-containing glycidyl ester contained a polyether segment and had a molecular formula of CH₂═CHCH₂(OCH₂CH₂)ₙOCH₂COOCH₂CH(O)CH₂, wherein n was 5.

### Comparative Example 2

A fast-dissolving polyacrylamide for offshore oil displacement differs from Example 1 in that the modified monomer solution is different. In this comparative example, the preparation process of the modified monomer solution was as follows:

15 kg of glycidol and 10 kg of diamino silicone oil were added into 500 kg of an isopropanol solution with a mass fraction of 20%, stirred uniformly to obtain a mixture, a pH value of the mixture was adjusted to 9 with sodium hydroxide, then the mixture was heated to 40° C. for reaction to obtain a modified monomer solution. Among them, the diamino silicone oil used was diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m was 10.

### Comparative Example 3

A fast-dissolving polyacrylamide for offshore oil displacement differs from Example 1 in that the modified monomer solution is different. In this comparative example, the preparation process of the modified monomer solution was as follows:

15 kg of a carbon-carbon double bond-containing glycidyl ester and 10 kg of diamino silicone oil were added into 500 kg of an isopropanol solution with a mass fraction of 20%, stirred uniformly to obtain a mixture, then the mixture was heated to 40° C. for reaction to obtain a modified monomer solution. Among them, the carbon-carbon double bond-containing glycidyl ester contained a polyether segment and had a molecular formula of CH₂═CHCH₂(OCH₂CH₂)ₙOCH₂COOCH₂CH(O)CH₂, wherein n was 5; the diamino silicone oil used was diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m was 10.

### Comparative Example 4

A fast-dissolving polyacrylamide for offshore oil displacement differs from Example 1 in that the mixed solution is different. In this comparative example, the mixed solution was prepared as follows:

40 kg of an acrylamide aqueous solution with a mass concentration of 30%, 25 kg of an acrylic acid aqueous solution with a mass concentration of 20%, 20 kg of an N-vinylpyrrolidone aqueous solution with a mass concentration of 0.5%, 5 kg of a 2-acrylamide-2-methyl propanesulfonic acid aqueous solution with a mass concentration of 3%, and 10 kg of the modified monomer solution were mixed uniformly, then 0.001 kg of a shielding agent and 1 kg of a chain transfer agent were added, stirred uniformly, and then purged with nitrogen to remove oxygen to obtain a mixed solution. Among them, the shielding agent used was disodium ethylenediamine tetraacetate, and the chain transfer agent used was sodium formate.

### Performance Testing

1. Molecular weight: Tested in accordance with Section 6.13 of Q/SH 0237-2008, and the results are recorded in Table 1 below.
2. Dissolution time: Tested in accordance with the determination method of dissolution rate of powdered polyacrylamide in GB/T 12005.8-1989, and the results are recorded in Table 1 below.
3. Residual acrylamide content: Tested in accordance with Section 6.10 of Q/SH 0237-2008, and the results are recorded in Table 1 below.
4. Shear-viscosity retention rate: Tested in accordance with Section 6.8 of Q/SH 0237-2008, using Brine II, and the results are recorded in Table 2 below.
5. Thermal aging viscosity retention rate: Tested in accordance with Section 6.12 of Q/SH 0237-2008, Brine II was used, with an experimental temperature of 80° C., the thermal aging times were 7 days and 1 month respectively, and the results are recorded in Table 2 below.

TABLE 1

| | | | Residual |
|---|---|---|---|
| | Molecular | Dissolution | monomer |
| Sample | weight/million | time/min | content/% |
| Example 1 | 19.80 | ≤10 | 0.08 |
| Example 2 | 20.10 | ≤10 | 0.06 |
| Example 3 | 20.00 | ≤10 | 0.07 |
| Example 4 | 20.30 | ≤10 | 0.07 |
| Example 5 | 20.60 | ≤10 | 0.06 |
| Example 6 | 20.50 | ≤10 | 0.06 |
| Example 7 | 20.50 | ≤10 | 0.08 |
| Example 8 | 20.60 | ≤10 | 0.06 |
| Example 9 | 20.50 | ≤10 | 0.07 |
| Example 10 | 21.00 | ≤10 | <0.001 |
| Example 11 | 20.70 | ≤10 | 0.06 |
| Example 12 | 18.90 | ≤10 | 0.19 |
| Comparative Example 1 | 17.60 | ≤10 | 0.28 |
| Comparative Example 2 | 15.40 | ≤10 | 0.46 |
| Comparative Example 3 | 17.30 | ≤10 | 0.29 |
| Comparative Example 4 | 16.80 | ≤10 | 0.36 |

It can be seen from Examples 1-12 in combination with the data in Table 1 that the molecular weights of the polyacrylamide prepared in the present application are all close to 20 million, and the dissolution times are all within 10 minutes, allowing for rapid dissolution and not affecting oil recovery efficiency due to the slow dissolution rate of polyacrylamide. In addition, in the polyacrylamide prepared in the present application, the residual acrylamide monomer is less than 0.10, indicating good safety performance. Among them, the polyacrylamide prepared in Example 10 has the least residual acrylamide, indicating that the addition of the initiator aqueous solution in multiple steps and in a manner of slow-to-fast dropwise addition can effectively reduce the residual amount of acrylamide in the polyacrylamide.

TABLE 2

Viscosity retention rate/%

Thermal aging

| Sample | Shear | 7 days | 1 month |
|---|---|---|---|
| Example 1 | 82.6 | 91.5 | 82.3 |
| Example 2 | 86.9 | 93.4 | 84.6 |
| Example 3 | 83.4 | 90.8 | 81.4 |
| Example 4 | 87.8 | 94.6 | 86.1 |
| Example 5 | 87.1 | 93.9 | 84.9 |
| Example 6 | 93.5 | 97.9 | 91.4 |
| Example 7 | 90.8 | 96.7 | 88.1 |
| Example 8 | 96.6 | 99.1 | 94.2 |
| Example 9 | 94.5 | 98.9 | 92.8 |
| Example 10 | 97.3 | 99.8 | 98.7 |
| Example 11 | 96.9 | 99.4 | 94.5 |
| Example 12 | 89.1 | 91.5 | 83.7 |
| Comparative Example 1 | 65.7 | 82.5 | 61.9 |
| Comparative Example 2 | 63.4 | 81.2 | 58.9 |
| Comparative Example 3 | 72.9 | 84.6 | 65.2 |
| Comparative Example 4 | 68.8 | 83.7 | 62.2 |

It can be seen from Example 1 and Comparative Examples 1-3 in combination with the data in Table 2 that the polyacrylamide obtained by copolymerizing the modified monomer solution obtained by reacting the carbon-carbon double bond-containing glycidyl ester with the diamino silicone oil in an environment with a pH value of 9-10 with acrylamide, acrylic acid, N-vinylpyrrolidone, and 2-acrylamide-2-methyl propanesulfonic acid has excellent shear resistance, high-temperature resistance, and high salt tolerance.

It can be seen from Example 1 and Comparative Example 4 in combination with the data in Table 2 that the ratio of the comonomers affects the shear resistance, high-temperature resistance, and high salt tolerance of the polyacrylamide.

It can be seen from Examples 1-3 in combination with the data in Table 2 that when the carbon-carbon double bond-containing glycidyl ester is within a range of 20-28 parts by weight, the diamino silicone oil is within a range of 14-18 parts by weight, and the alcohol solution is within a range of 600-800 parts by weight, the modified monomer obtained is copolymerized with acrylamide, acrylic acid, N-vinylpyrrolidone, and 2-acrylamide-2-methyl propanesulfonic acid, thereby further improving the shear resistance, high-temperature resistance, and high salt tolerance of the polyacrylamide.

It can be seen from Example 4 and Examples 6-9 in combination with the data in Table 2 that when the carbon-carbon double bond-containing glycidyl ester used is a glycidyl ester having a molecular formula of CH₂═CHCH₂(OCH₂CH₂)ₙOCH₂COOCH₂CH(O)CH₂, wherein n ranges from 8 to 12, the shear resistance, high-temperature resistance, and high salt tolerance of the polyacrylamide are improved. In addition, when the diamino silicone oil used is diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m ranges from 15 to 20, the shear resistance, high-temperature resistance, and high salt tolerance of the polyacrylamide are improved.

It can be seen from Example 8 and Examples 10-11 in combination with the data in Table 2 that the viscosity retention rate of polyacrylamide in Example 10 under high temperature and high salt conditions is significantly higher than that in Examples 8-9 and 11, indicating that the addition of the initiator aqueous solution in multiple steps and in a manner of slow-to-fast dropwise addition is beneficial to further improving the stability of the high-temperature resistance and high salt tolerance of the polyacrylamide.

The foregoing detailed description is merely illustrative of the present application and is not intended to limit the present application. After reading this specification, those skilled in the art may make modifications to the embodiments without creative contribution as desired. However, all such modifications shall be protected by patent law as long as they fall within the scope of the claims of the present application.

What is claimed is:

1. A method for preparing a fast-dissolving polyacrylamide for offshore oil displacement, comprising the following steps:
adding 15-45 parts by weight of a carbon-carbon double bond-containing glycidyl ester and 10-25 parts by weight of a diamino silicone oil into 500-1,000 parts by weight of an alcohol solution, stirring uniformly to obtain a mixture, adjusting a pH value of the mixture to 9-10 with an alkali, then heating to 30-50° C. for reaction to obtain a modified monomer solution;
uniformly mixing 40-50 parts by weight of an acrylamide aqueous solution with a mass concentration of 20-40%, 10-15 parts by weight of an acrylic acid aqueous solution with a mass concentration of 10-30%, 5-10 parts by weight of an N-vinylpyrrolidone aqueous solution with a mass concentration of 0.3-0.8%, 10-20 parts by weight of a 2-acrylamide-2-methyl propanesulfonic acid aqueous solution with a mass concentration of 1-5%, and 15-25 parts by weight of the modified monomer solution, then adding 0.001-0.002 parts by weight of a shielding agent and 1-3 parts by weight of a chain transfer agent, stirring uniformly, and then purging with nitrogen to remove oxygen to obtain a mixed solution; and
adjusting a temperature of the mixed solution to (−2° C.) to 5° C., then under a protection of nitrogen, dropwise adding 3-5 parts by weight of an initiator aqueous solution with a mass concentration of 0.1%-0.3% into the mixed solution, reacting for 4-8 h after addition of the initiator aqueous solution is completed, then adding a cosolvent, stirring uniformly, followed by discharging, pelletizing, and drying to obtain the fast-dissolving polyacrylamide.

2. The method for preparing a fast-dissolving polyacrylamide for offshore oil displacement according to claim 1, wherein the carbon-carbon double bond-containing glycidyl ester has a molecular formula of CH₂═CHCH₂(OCH₂CH₂)ₙOCH₂COOCH₂CH(O)CH₂, wherein n ranges from 5 to 20.

3. The method for preparing a fast-dissolving polyacrylamide for offshore oil displacement according to claim 2, wherein the n ranges from 8 to 12.

4. The method for preparing a fast-dissolving polyacrylamide for offshore oil displacement according to claim 1, wherein the diamino silicone oil is diaminopropyl polydimethylsiloxane having a molecular formula of H₂N(CH₂)₃Si(CH₃)₂O[Si(CH₃)₂O]ₘSi(CH₃)₂(CH₂)₃NH₂, wherein m ranges from 10 to 30.

5. The method for preparing a fast-dissolving polyacrylamide for offshore oil displacement according to claim 4, wherein the m ranges from 15 to 20.

6. The method for preparing a fast-dissolving polyacrylamide for offshore oil displacement according to claim 1, wherein the modified monomer solution comprises 20-28 parts by weight of the carbon-carbon double bond-containing glycidyl ester, 14-18 parts by weight of the diamino silicone oil, and 600-800 parts by weight of the alcohol solution.

7. The method for preparing a fast-dissolving polyacrylamide for offshore oil displacement according to claim 1, wherein before adding the initiator aqueous solution, the temperature of the mixed solution is (−1° C.) to 1° C.

8. The method for preparing a fast-dissolving polyacrylamide for offshore oil displacement according to claim 1, wherein the initiator aqueous solution is added in three portions; an amount of a first addition of the initiator aqueous solution is 25-35 wt % of a total amount of the initiator aqueous solution, with a dropwise addition rate of 0.05-0.1 g/min; an amount of a second addition of the initiator aqueous solution is 40-50 wt % of the total amount of the initiator aqueous solution, with a dropwise addition rate of 0.1-0.2 g/min; and a dropwise addition rate for a third addition of the initiator aqueous solution is 0.2-0.5 g/min, and an interval time between two successive additions of the initiator aqueous solution is 30-45 minutes.

9. The method for preparing a fast-dissolving polyacrylamide for offshore oil displacement according to claim 1, wherein the cosolvent is one or more selected from a group consisting of sodium carboxymethyl starch, sodium starch glycolate, polyvinylpyrrolidone, and sodium carboxymethylcellulose.

10. A polyacrylamide prepared by the method for preparing a fast-dissolving polyacrylamide for offshore oil displacement according to claim 1.
